(19) United States
(12) Patent Application Publication
(10) Pub. No.: US 2017/0255949 A1
(43) Pub. Date: Sep. 7, 2017

(54) PROCESS TO EXTRACT, COMPARE AND DISTILL CHAIN-OF-EVENTS TO DETERMINE THE ACTIONABLE STATE OF MIND OF AN INDIVIDUAL

(71) Applicant: Neural Insight Inc., Toronto (CA)

(72) Inventors: Crishanth SILVALINGAM, Aurora (CA); Han YAN, Richmond Hill (CA)

(21) Appl. No.: 15/450,185

(22) Filed: Mar. 6, 2017

Related U.S. Application Data
(60) Provisional application No. 62/303,792, filed on Mar. 4, 2016.

(51) Int. Cl. G06Q 30/02; G06N 99/00

(52) U.S. Cl. CPC G06Q 30/0201; G06Q 30/0239; G06N 99/005

(57) ABSTRACT

A computer system and process for extracting, comparing and distilling a chain-of-events for decision making. The system and process involves the following operations: generate or obtain a set of event rules that define events as a function of a pattern of data relating to customer transaction; receive or retrieve, by a processor, real-time transaction data feeds having a plurality of data sets; aggregate the real-time transaction data feeds with daily data feeds to generate an aggregated transaction data feed; generate an intermediate data stream by extracting, using the processor, data structures for event outputs by evaluating the aggregated transaction data feed against the set of event rules; generate a set of insight rules as a function of a pattern relating to customer decision making behaviour; and generate a chain of events for a consumer by evaluating the data structures for event outputs against the insight rules.

### FIELD

The present disclosure relates generally to processes and systems for gathering and processing data signals defining consumer intelligence to generate output data and external controls.

### BACKGROUND

On any given day, an individual may walk an extra few minutes to visit his or her favourite coffee shop or book store during lunch hour. Logically, it would make more sense to go the closest cafe or surf online to buy that favourite book. So what is the thinking that motivated the individual's decision? It would be to satisfy his or her actionable state of mind. Human behaviour cannot be boiled down to a single cause.

### SUMMARY

In an aspect, embodiments described herein provide a computer-implemented process for extracting, comparing and distilling a chain-of-events for decision making. The process may include: receiving or retrieving, by a processor, consumer data regarding one or more consumers; extracting, by the processor, event data representing a chain of events for each consumer based on the respective consumer data; and generating, by the processor, a consumer profile based on the consumer data and the event data, wherein the processor makes available the consumer profile via data storage or transmission. For example, the consumer profile may be used to generate additional data for offers or complete missing data fields for user account information.

In another aspect, a computer device for extracting, comparing and distilling a chain-of-events for decision making is disclosed. The device may include a processor and a memory. The processor may be configured to: receive or retrieve consumer data regarding one or more consumers; generate event data representing a chain of events for each consumer based on the respective consumer data; and extract a consumer profile based on the consumer data and the event data.

In an aspect, embodiments described herein provide a computer-implemented process for automatically extracting, comparing and distilling a chain-of-events for decision making from real-time transaction data feeds. The process involves generating or obtaining a set of event rules that define events as a function of a pattern of data relating to customer transaction. The process involves receiving or retrieving, by a processor, real-time transaction data feeds having a plurality of data sets. The process involves aggregating the real-time transaction data feeds with daily data feeds to generate an aggregated transaction data feed. The process involves generating an intermediate data stream by extracting, using the processor, data structures for event outputs by evaluating the aggregated transaction data feed against the set of event rules. The process involves generating a set of insight rules as a function of a pattern relating to customer decision making behaviour. The process involves generating a chain of events for a consumer by evaluating the data structures for event outputs against the insight rules. The process involves generating, by the processor, a consumer profile based on the real-time transaction data feeds and the chain of events. The process involves applying the chain of events to produce additional consumer data and an electronic offer. The process involves updating the consumer profile by adding the additional consumer data. The process involves making available, by the processor, the consumer profile and the electronic offer through data storage or transmission.

In some embodiments, the process involves receiving confirmation of the chain of events as a machine learning feedback loop; and updating the set of event rules and the set of insight rules based on the confirmation.

In some embodiments, the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the data channels comprise web channels, mobile channels, banking machine channels, call center channels, retail channels, bank channels, and email channels.

In some embodiments, the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

In some embodiments, a set of curation rules ensure data from all sources are reliable and retrievable in an enterprise view.

In some embodiments, the set of event rules include a weight for relevancy, the weight evaluated based on feedback to drive changes of the weighting of each event rule dynamically based on machine learning component such that new and updated event rules feedback in real time for real-time data processing.

In an aspect, embodiments described herein provide a computer system for extracting, comparing and distilling a chain-of-events for decision making. The system has a rules engine for generating or obtaining a set of event rules that define events as a function of a pattern of data relating to customer transaction. The system has a customer hub for ingesting, aggregating and caching, real-time transaction data feeds having a plurality of data sets, the customer hub aggregating the real-time transaction data feeds with daily data feeds to generate an aggregated transaction data feed. The system has a model manager for generating models for a set of insight rules as a function of a pattern relating to customer decision making behaviour. The system has an insight hub for generating an intermediate data stream by extracting, using the processor, data structures for event outputs by evaluating the aggregated transaction data feed against the set of event rules. The system has an engagement hub generating a chain of events for a consumer by evaluating the data structures for event outputs against the insight rules. The engagement hub is for applying the chain of events to produce additional consumer data and an electronic offer. The customer hub is for generating, by the processor, a consumer profile based on the real-time transaction data feeds and the chain of events, updating the consumer profile by adding the additional consumer data, and making available, by the processor, the consumer profile and the electronic offer through data storage or transmission.

In some embodiments, the customer hub is for receiving confirmation of the chain of events as a machine learning feedback loop; and updating the set of event rules and the set of insight rules based on the confirmation.

In some embodiments, the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the data channels comprise web channels, mobile channels, banking machine channels, call center channels, retail channels, bank channels, and email channels.

In some embodiments, the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

In some embodiments, the set of event rules include a weight for relevancy, the weight evaluated based on feedback to drive changes of the weighting of each event rule dynamically based on machine learning component such that new and updated event rules feedback in real time for real-time data processing.

In an aspect, embodiments described herein provide a computer device for extracting, comparing and distilling a chain-of-events for decision making, the device comprising a processor and a memory. The processor being configured to: generate or obtain a set of event rules that define events as a function of a pattern of data relating to customer transaction; receive or retrieve, by a processor, real-time transaction data feeds having a plurality of data sets; aggregate the real-time transaction data feeds with daily data feeds to generate an aggregated transaction data feed; generate an intermediate data stream by extracting, using the processor, data structures for event outputs by evaluating the aggregated transaction data feed against the set of event rules; generate a set of insight rules as a function of a pattern relating to customer decision making behaviour; generate a chain of events for a consumer by evaluating the data structures for event outputs against the insight rules; generate, by the processor, a consumer profile based on the real-time transaction data feeds and the chain of events; apply the chain of events to produce additional consumer data and an electronic offer; update the consumer profile by adding the additional consumer data; make available, by the processor, the consumer profile and the electronic offer through data storage or transmission; receive confirmation of the chain of events as a machine learning feedback loop; update the set of event rules and the set of insight rules based on the confirmation.

### BRIEF DESCRIPTION OF THE DRAWINGS

In the drawings, embodiments of the present disclosure are illustrated by way of example. It is to be expressly understood that the description and drawings are only for the purpose of illustration and as an aid to understanding, and are not intended as a definition of the limits of the present disclosure.

Embodiments will now be described, by way of example only, with reference to the attached figures, wherein:

FIG. 1 is an example schematic diagram of a system for generating and processing chain-of-events for decision making, according to some embodiments.

FIG. 2 is an example schematic diagram of a computing device for generating and processing chain-of-events for decision making, according to some embodiments.

FIG. 3 is a schematic diagram of a system for generating and processing chain-of-events for decision making according to some embodiments.

FIG. 4 is a schematic diagram of a system for generating and processing chain-of-events for decision making according to some embodiments.

FIG. 5 is an example diagram of events according to some embodiments.

FIG. 6 is an example diagram of events according to some embodiments.

FIG. 7 is a schematic diagram of a system for generating and processing chain-of-events for decision making according to some embodiments.

FIG. 8 is a schematic diagram of a system for generating and processing chain-of-events for decision making according to some embodiments.

FIG. 9 is a schematic diagram of a process for generating and processing chain-of-events for decision making according to some embodiments.

### DETAILED DESCRIPTION

More specifically, the present disclosure relates to processes and systems to extract compare and distill out, the relevant ‘chain-of-events’ that lead to an individual making a tangible buying/engagement decision based on human brain's cognitive compulsion patterns. Embodiments described herein provide an automated way to process data feeds in real time to identify events and ingest event related data in a parallel feedback loop. This enables automated identification and generation of insight data relating to chain of events that lead to decision-making. Embodiments described herein include a dynamic rules engine to improve computer-related technology by allowing computer performance of a function not previously performable by a computer, namely the automated ingestion and processing of events extracted from data feeds for insight data model generation. Further details will be described herein.

A computer-implemented process may automatically and electronically extract process and distill a set of correlation processes between an individual's social behaviour or activities and their compulsion to respond to a consumer offer or action.

An individual's compulsion to respond to a consumer offer or action may not be a single event, it may contain a chain of events that may be electronically modeled by transforming event data from data feeds to generate output correlations by a processor. This chain of events may be different for different offers or actions; and the chain of events may be different for different individuals.

Embodiments described herein relate to a process and mechanism of identifying in modelling chain of events that provide insight to a compulsive environment/mind set for an individual to react positively to a consumer offer or action based on their social and channel behaviour.

For example, processes may be used to extract electronic data representing the set of chain-of-events that are related to an individual's cognitive compulsion patterns from real-time data feeds.

Information may be processed in two different methods: emotional and rational. For example, Maslow's hierarchy of needs provides a theory of human motivation. Consumer behaviour related to buying or reacting to an offer consists of the same mental triggers that drive all human cognitive reflection and decision making. Embodiments described herein may use a processor to automatically extract and model insight from events to understand the triggers and emotions behind why people buy, accept an offer or perform an action, to automatically apply those models to artificially establish and influence the consumer's state of mind where selling or promoting an offer becomes successful. Consumers tend to buy what they buy based on a respective state of mind.

Most of human decision making is subconscious; based on emotionally formed habits and memories. These habits and memories can be organised by a chain-of-events. Interestingly, not everyone is motivated by the same combination of emotional triggers. And the combination may be different in each decision. Different combinations of triggers may lead to alternative actions.

Positive customer experiences may reinforce certain cognitive compulsion patterns, which are like highways in the brain. Each chain-of-events related to a particular subconscious habit or memory can be organised under a respective cognitive compulsion pattern.

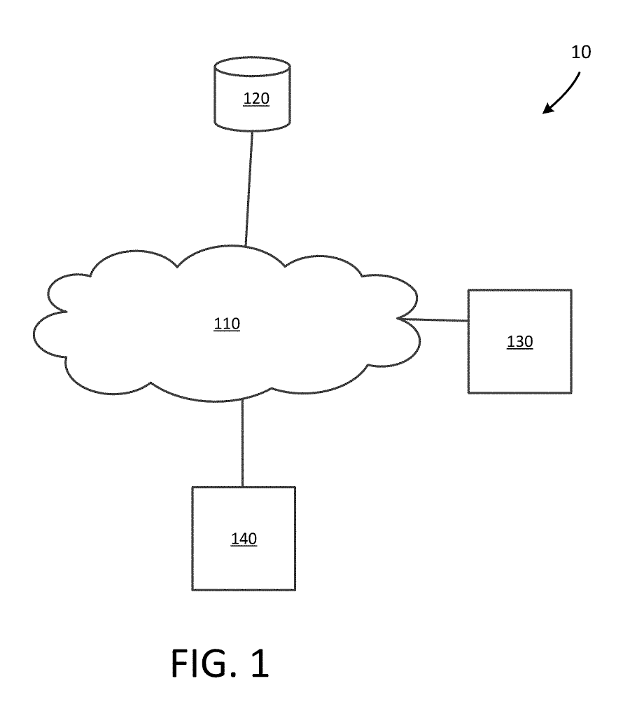

Turning now to FIG. 1, a system 10 for generating and processing chain-of-events for decision making may include a database 120, a server 130 and a web platform 140 distributed across a network 110.

Various components of system 10, such as database 120, server 130, and web platform 140 may be implemented using hardware and software, individually or in combination, and may be fixed and/or provided in various electronic forms, such as on non-transitory computer-readable media having instructions stored thereon, distributed network resources (e.g., in a “cloud computing” arrangement or a spoke-and-hub topology), and web service. In some embodiments, the system may be provided using a centralized cloud server, having various endpoint devices that it may communicate and/or control. In some embodiments, the system may be provided in the form of an ad-hoc network operating across one or more computing devices.

System 10 may interact with a range of enterprise platforms to store or retrieve data, in real-time or in data batches.

System 10 may connect with or include one or more data storage devices or databases 120 (e.g., memory), and could include a relational database (such as a SQL database), or other suitable data storage mechanisms. Data storage devices are operable to store data records for system, and associated applications such as data for provision to user devices or data received from user devices. A cloud based data storage device may be accessible to user device through a cloud services interface. Cloud computing generally is the use of computing hardware and software resources that are delivered as a service over a network to user device or engagement system. Data storage devices may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. In some embodiments, the engagement system may also have one or more backup servers that may duplicate some or all of the data stored on the data storage devices. The backup servers may be desirable for disaster recovery (e.g., to prevent undesired data loss in the event of an event such as a fire, flooding, or theft). In some embodiments, the backup servers may be directly connected to the system 10 but located at a different physical location.

In one embodiment, database 120 may store consumer data and consumer profiles. Consumer data may include various customer attributes including consumer name, address, nationality, address, spending habits, favourite stores, and so on. In one embodiment, database 120 may store extracted chain-of-events data regarding each consumer. The chain-of-events data may be part of a consumer profile.

Web platform 140 may provide marketers or enterprise users with the ability to recreate desired emotional experience, identify individual's actionable state of mind, and uncover behavioural patterns otherwise impossible. In one embodiment, web platform 140 may include one or more enterprise interfaces or one or more consumer interfaces. An enterprise interface may be designed to allow interaction with marketers or enterprise users. A consumer interface may be designed to allow interactions with consumers.

For example, web platform 140 may use games to improve customer engagement. Applications may be designed to bring customer data to life, and provide insight based on behavioural analysis.

Web platform 140 may receive one or more sets of data from enterprise or consumer interface. The data may be stored locally or may be transmitted via network 110 to database 120. Sets of data may be referred to as data feeds.

For example, data feeds can include transactional data from social media, purchasing interactions, financial interactions, customer channel interactions, and other types of real-time (or near real-time) actionable, consumer behavioural data made possible by ‘The Internet of Things’ may be captured by web platform 140 or server 130 for storage and further processing.

Web platform 140 may be operable to receive processed data including extracted chain-of-events data from server 130 via network 110 and display the data to users via enterprise or consumer interface.

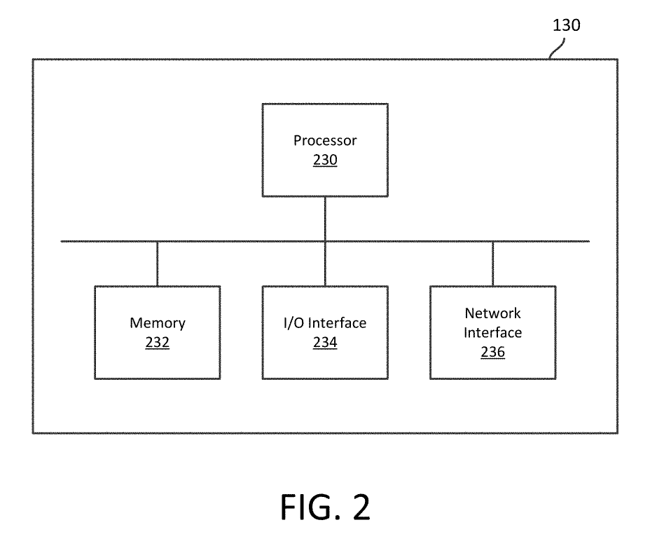

FIG. 2 shows an example schematic block diagram of a computing device for generating and processing chain-of-events for decision making, according to some embodiments. In an embodiment, server 130 may be implemented using one or more computing devices. The computing devices may be the same or different types of devices. The computing device may include, for example, at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

For example, and without limitation, the computing device may be a server, network appliance, embedded device, personal computer, or any other computing device capable of being configured to carry out the methods described herein.

FIG. 2 is a schematic diagram of an example computing device that may be used to implement server 130, exemplary of an embodiment. As depicted, computing device may include at least one processor 230, memory 232, at least one I/O interface 234, and at least one network interface 236. Although this figure relates to a server 130, in some embodiments audio processor may include similar hardware components to receive and process sound waves to detect trigger events from snoring sounds. For example, I/O interface 234 may connect to one or more microphones to receive sound waves for processing.

Each processor 230 may be, for example, any type of general-purpose microprocessor or microserver, a digital signal processing (DSP) processor, an integrated circuit, a field programmable gate array (FPGA), a reconfigurable processor, or any combination thereof. As noted, for audio processor, the processor 230 may be configured to execute code instructions to implement processes for detecting snoring events or other trigger events, as will be described herein. The processor 230 is configured to implement rules to automatically process data feeds to extract events and then process the events to generate insight data models as will be described herein.

Memory 232 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 234 enables server 130 to interconnect with one or more components, input devices, such as a keyboard, mouse, camera, touch screen and a microphone, or with one or more output devices such as a display screen and a speaker.

Each network interface 236 enables server 130 to communicate with other components (such as audio processor, conduit, for example), to exchange data with other components, to access and connect to network resources, to serve applications, and perform other computing applications by connecting to a network (or multiple networks) capable of carrying data, e.g., one more networks 110.

In some embodiments, server 130 may be implemented as a physical or virtual instance using various distributed-resource technologies, such as “cloud computing”. Potential benefits to cloud computing include ease of adding or removing resources, load balancing, and so on.

Server 130 may include various units such as data acquisition unit, data analytics unit, and data processing unit to process, validate and extract data.

Transactional data from social media, purchasing interactions, financial interactions, customer channel interactions, and ‘The Internet of Things’ provides unparalleled opportunities for real-time, actionable, consumer behavioural data. Such data may be captured and processed by web platform 140 or server 130 as data feeds. For example, data may be acquired from enterprise or consumer interfaces of web platform 140, or may be retrieved by server 130 from one or more data stores, including database 120.

In one embodiment, in order to gain actionable insights from this data, server 130 may be configured to decode the chain-of-events data associated with consumer buying or an engagement process. A relationship between consumer behaviour and the chain-of-events that lead up to an actionable state of mind may be determined which may be used to generate electronic offers for vendible items.

An actionable state of mind may be the tipping point where a consumer makes that final decision to put that gadget in the shopping cart or makes the detour to go to a favorite cafe. The relevant chain-of-events that leads up to the tipping point may be extracted by the system 10. This may involve comparing the chain-of-events data to the associated cognitive compulsion patterns, in order to understand the ‘true intent’.

In one aspect, server 130 may include a data analytics or data mining unit (e.g. “Neural Insight Miner”) which may utilize a set of processes to extract, compare and distill out, the relevant ‘chain-of-events’ that lead to an individual making a tangible buying/engagement decision. The data analytics unit may implement scientific algorithms, to derive and correlate the ‘chain-of-events’ related to an individual's evidential behaviour against the intended actionable behaviour based on human cognitive compulsion patterns.

The chain-of-events data may then be stored in database 120.

Insights gained from the data analytics unit may be used in the form of specific “chain-of-events” that may subconsciously trigger an individual's emotions and artificially and influence the state of mind that is conductive for the action that is expected to be performed. This may be done at scale, using big data, in real-time or near real-time.

By continually scoring, and re-scoring, customer attributes, the data analytics unit may provide ‘out-of-box’ data models that rapidly benchmark customers, building a profile as the customer relationship matures.

The consumer profiles may be stored in database 120.

Industry specific Customer Profiling Models may give a turn-key solution without having to create complex algorithms for specific data sets. Instead, the embodiments described herein provide a machine learning parallel process to ingest data feeds in real time to generate events and insight models. For example, system 10 may be used to provide consumer insights for Banking and Finance, Insurance, Retail & Loyalty industries.

In one embodiment, a Neural Interaction Optimizer unit implemented by server 130 may work with existing workflows, decision engines, and channel applications, to recreate the chain-of-events that may bring a customer to their actionable state of mind—and guide them towards accepting the next best action/offer.

System 10 may deliver faster, cheaper, more accurate data—and leverage it to create opportunities. The solution may organizations from reactive to proactive in three ways: engaging customers one-on-one, optimizing sales, and providing a truly omnichannel customer experience.

With web platform 140, marketers may have the ability to recreate the desired emotional experience electronically, identify individual's actionable state of mind to generate timely and relevant offers for vendible items, and uncover behavioural patterns otherwise impossible, through for example enterprise interface of the web platform 140.

In one embodiment, the platform 140 may use games to improve customer engagement through consumer interface by triggering and controlling display of electronic items associated with the consumer profile. Applications may be designed to bring customer data to life, and provide insight based on behavioural analysis. Experiences are social and may quickly grow leads.

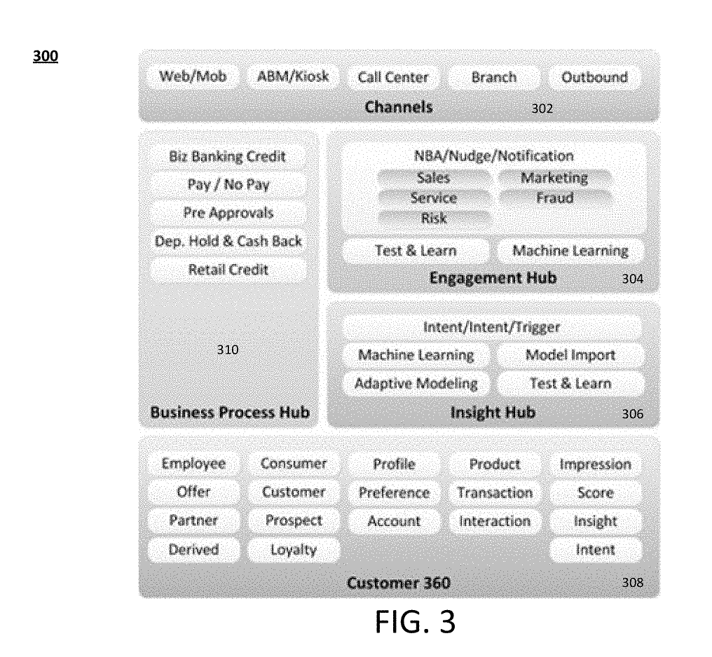

FIG. 3 is a schematic diagram of a system 300 for extracting and processing cognitive compulsion patterns, according to some embodiments. System 300 includes channels 3024 receiving input data and transmitting output data. Channels 302 can include a web or mobile channel, automated banking machine or kiosk channel, call centre channel, branch channel, and an outbound channel. These channels 302 relate to a financial institution for example. Channels 302 can include an application programming interface or API to exchange data with external devices or systems. The channels 302 can provide real time data feeds to system 300. Business process hub 310 can define one or more rules to manage different business processes. Business process hub 310 can include business banking credit unit, a pay or no pay unit, a preapprovals unit, a deposit hold and cashback unit, and a retail credit unit. Engagement hub 304 receives data feeds from channels 302 to automatically generate events. Engagement hub 304 includes a notification unit covering different functions including sales, service, risk, marketing, and fraud. Engagement hub 304 also includes machine learning rules to automate the generation of events. Engagement hub 304 also includes the test and learning unit to receive feedback to improve machine learning rules. Insight hub 306 includes processes the events to automatically generate insight models. Insight hub includes unintended and trigger unit to process events and trigger processes in response. Insight hub 306 includes a machine learning unit with rules to automate the generation of insight models. Insight hub 306 includes a model import unit to import insight models for training and updating. Insight hub includes an adaptive modelling unit to update the insight models. Insight hub 306 includes a test and learn unit to generate a feedback loop to update the machine learning and adaptive modelling. Customer hub 308 includes different functional units such as for example units for employees, customers, consumers, profiles, offers, partners, loyalty, preferences, accounts, products, transactions, interactions, impressions, scores, insight and intent.

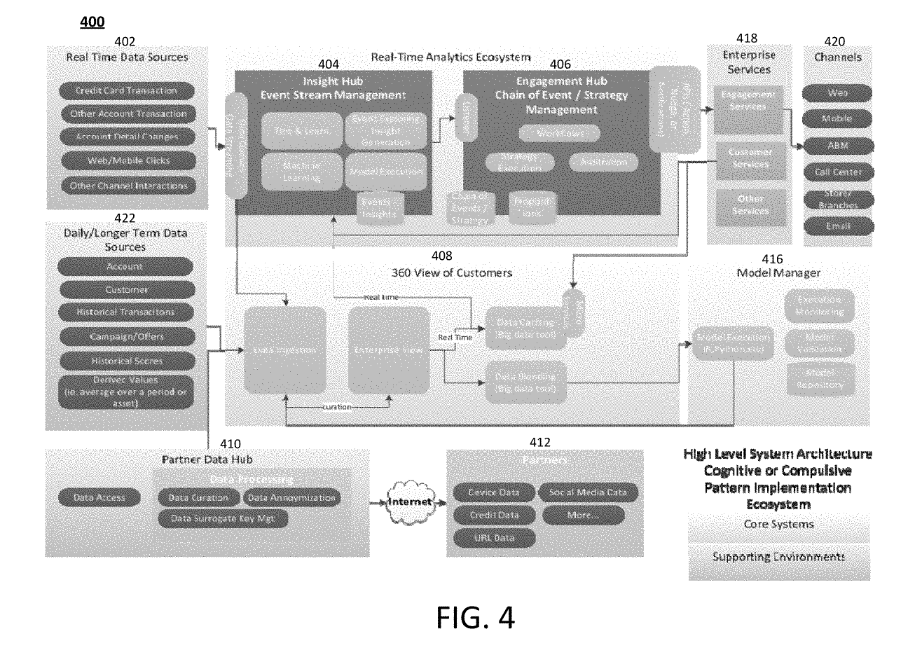

FIG. 4 is a schematic diagram of a system 400 for extracting and processing patterns, events and insights according to some embodiments. The system 400 receives data feeds from real-time data sources 402. In particular, data sources 402 provide data feeds to insight hub and engagement hub. Data sources 402 include real time data feeds from credit card transactions, account transactions, account detail changes, web and mobile interactions, and other channel interactions.

Insight hub 404 receives data feeds in real time. Insight hub 404 includes a data queue and data streaming unit to manage the incoming data feeds. Insight hub 404 processes data sources to generate events and insights. Insight hub 404 includes a test and learn unit to provide feedback on the processing to refine machine learning rules. Insight hub 404 includes a model execution unit to process data sources using event and insight models. Insight hub 404 includes an event and insight generation unit to generate events and insights. Insight hub 404 stores the events and insights in database.

Insight hub 404 has a rules engine for generating or obtaining a set of event rules that define events as a function of a pattern of data relating to customer transaction. Insight hub 404 has a database for event rules and insight rules. Insight hub 404 is for generating an intermediate data stream by extracting, using the processor, data structures for event outputs by evaluating the aggregated transaction data feed against the set of event rules.

A model manager 416 is for generating models for a set of insight rules as a function of a pattern relating to customer decision making behaviour.

Engagement hub 406 includes workflows to generate chain of events and propositions. Engagement hub 406 includes a listener to pull for event in insight data from insight hub 404. Engagement hub 406 generates chains of events from the events in insights and stores them in database. Engagement hub 406 also includes a strategy execution unit to generate strategies based on the events and insights. Insight hub 404 processes events and links the events and insights to drive a strategy execution in engagement hub 406. The relevant events are evaluated based on the feedback from enterprise service unit 418. The feedback from enterprise service unit 418 can drive changes of the weighting of each event relevancy in the chain of events dynamically. This is part of the machine learning component. New and updated insights/events feedback in real time to data caching of the customer unit 408 to drive next round of actions in enterprise services unit 418.

Engagement hub 406 is for generating a chain of events for a consumer by evaluating the data structures for event outputs against the insight rules. Engagement hub 406 is for applying the chain of events to produce additional consumer data and an electronic offer.

Customer hub 408 is for ingesting, aggregating and caching, real-time transaction data feeds having a plurality of data sets, the customer hub aggregating the real-time transaction data feeds with daily data feeds to generate an aggregated transaction data feed. Customer hub 408 is for generating a consumer profile based on the real-time transaction data feeds and the chain of events, updating the consumer profile by adding the additional consumer data, and making available, by the processor, the consumer profile and the electronic offer through data storage or transmission.

Enterprise services unit 418 interacts with engagement hub and 360 customer unit 408 by way of an application programming interface to exchange data. Enterprise services unit 418 includes engagement services, customer services, and other services. Enterprise services also connects with channels including web channels, mobile channels, banking machine channels, call-center channels, storm branch channels, and email channels.

The customer unit 408 includes a data ingestion unit, enterprise view, data caching, and data blending. The customer unit 408 process data feeds, events, and insights in real time and in parallel from different sources to ensure there is a reliable and aggregated data set. The customer unit 408 includes a data ingestion unit to receive data from data sources 402 long-term data sources 422 and partner data hub 410. The data ingestion unit interacts with model manager 416 to cure and process the data. An enterprise view unit receives a curated data from data ingestion unit and aggregates the data in real time for data caching unit and data blending unit. Data source 402 transits data feeds to data ingestion unit of the customer unit 408 where it gets aggregated with periodic data sources. The curation process ensures data feeds from the data sources 402 are reliable and retrievable in the enterprise view unit. As the curation takes processing time, the data caching component needs the most recent events in real time from insight hub 404 to support real time services in the enterprise view unit. Data blending takes the data from enterprise view 408 and enables event relationships which can be later drive changes in model manager 416. Data caching unit interacts with enterprise services unit 412 store data in real time. Data blending unit aggregates data from different components and provides the integrated data set to the model manager 416.

Model manager 416 manages insight models. Model manager includes model execution unit, execution monitoring unit, model validation unit, and a model repository.

Daily and long-term data sources 422 transmit data to customer unit 408. These other data sources 422 include account data, customer data, historical transaction data, campaign offers, historical scores, derived values, and other data.

The partner data hub 410 provides data feeds to the customer unit 408. The partner data hub 410 includes units for data access, data creation, data and optimization, and data surrogate key management. The partner data hub 410 connects with different partners 412 to access additional data such as device data, credit data, Internet data, social media data and so on.

System 400 is operable to automatically extract patterns from data feeds and generate events and insights. Different examples of patterns, events and insights that can be automatically created by system 400 are provided below. These patterns, events and insights can represent mind sets and behaviors of a user and are not mutually exclusive and often interconnected.

In some embodiments, the process involves receiving confirmation of the chain of events as a machine learning feedback loop; and updating the set of event rules and the set of insight rules based on the confirmation.

In some embodiments, the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the data channels comprise web channels, mobile channels, banking machine channels, call center channels, retail channels, bank channels, and email channels.

In some embodiments, the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

In some embodiments, a set of curation rules ensure data from all sources are reliable and retrievable in an enterprise view.

In some embodiments, the set of event rules include a weight for relevancy, the weight evaluated based on feedback to drive changes of the weighting of each event rule dynamically based on machine learning component such that new and updated event rules feedback in real time for real-time data processing.

An example rule defining a pattern and event can relate to cash flow behaviour. Cash flow behaviour patterns include a chain of events that impact an individual's cash flow management. For example, changes in someone's recurring spending on certain merchant types, changes an existing debt payment pattern, or a significant life event are sample events which can lead up to positive or negative reaction to an offer or nudge which impacts cash flow management. Accordingly system 400 can generate a chain of events that represents an individual's cash flow behaviour.

Another example rule defining a pattern and event can relate to channel usage behaviour patterns. Channel usage behavior patterns include a chain of events that impact an individual's choice of conducting a contact with any business any merchant. This type of pattern focuses on the best way to communicate certain topics with an individual based on the chain the events that can lead up to a positive or desired outcome. The context or the driver of the contact is critical to determine the relevant chain of events. One example is that certain people are comfortable to raise an issue via writing (emailing or texting) but would like to resolve issues in person.

Another example rule defining a pattern and event can relate to demographics. Demographic insight and behavior patterns include a chain of events that changes the impact level of people around individuals. Some individuals are highly influenced by relatives in the same household or extended household or close friends, while some are more influenced by social rating online.

A further example rule defining a pattern and event can relate to financial and transaction behaviour. Financial and transaction behavior patterns include a chain of events that impact an individual's financial health and financial network. This can identify both opportunities and risks for financial/insurance organizations. Detailed implementation of one of the patterns is provided.

A further example rule defining a pattern and event can relate to consumer behaviour. Consumer or shopping behavior patterns include a chain of events that impact an individual's spending. For example, this pattern investigates into what makes an individual to switch from purchasing in store to purchasing online for certain products. Detailed implementation of one of the patterns is provided.

Another example rule defining a pattern and event can relate to domain or industry insights. Critical domain or industry insights include impacts by knowledge of an individual in certain critical domains. An individual may have strong interests or professional knowledge in certain topics which can heavily influence the weighting of events in other patterns. For example, selling a car to a new driver who knows nothing about cars is very different from selling a car to an automotive technician.

A further example rule defining a pattern or event can relate to online behaviour. Online behavior includes behavior patterns in the virtual or non-physical environment. The behavior of people in the virtual society has been known to be different than in real life. The pattern looks into real life factual events and virtual events to understand an individual in both worlds.

Another example rule defining a pattern and event can relate to social behaviour. Social behavior patterns look into chain of events that impacts people's social status, legal abiding level, social awareness, environment awareness, and diversity and inclusion level to improve the positive response to certain ethnic or social offers.

Rules can define events based on a pattern of data that can occur in data feeds 402. The rules can process the data feed to extract events by evaluating the rules. The extracted events can be organized into a sequence of events which can be referred to as a chain of events. Insight rules can be used to evaluate chain of events and derive additional relevant data for the customer the additional data can be used to augment the customer profile and provide an enhanced data set. The additional data is generated automatically by system using the insight rules. The insight rules can also automatically generate electronic offers for the customer. Accordingly insight rules can be used to evaluate event data to generate additional customer data that may not be otherwise present in the real time data feeds. The rules can also correlate the real time data feeds with daily or longer-term data sources 422 to derive even further additional customer data. Accordingly the event rules and the insight rules are used automatically process data feeds to generate additional customer data. Rules can be used to process data sources 402 relating to different customers. Events that are identified in relation to one customer can be used to infer events relating to another customer if data feeds are sufficiently similar between the customers.

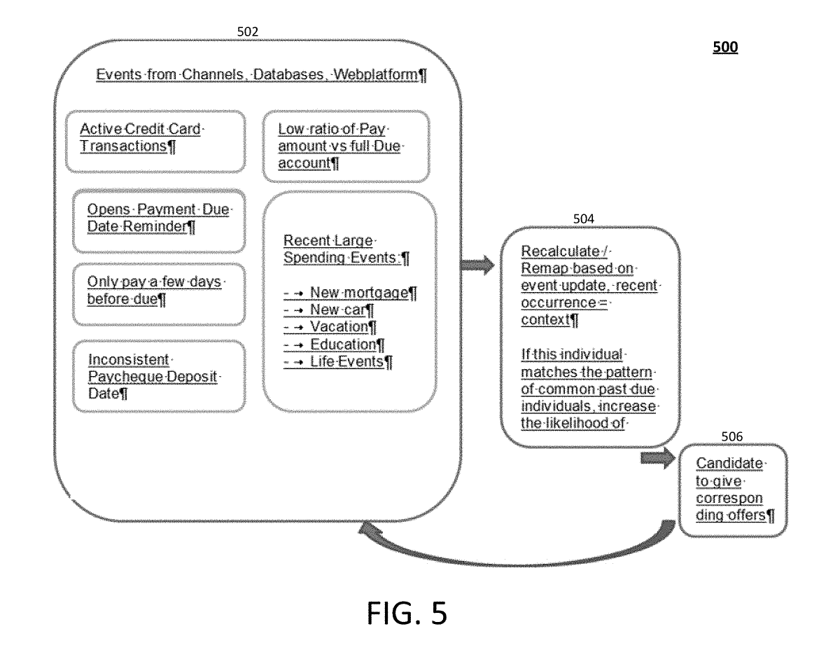

FIG. 5 is an example diagram of events 502 according to some embodiments. The events 502 can be generated from data sources such as channels, databases and web platform. In this example, events 502 include active credit card transactions, open payment due date reminders, alert reminders, inconsistent paycheck deposit date, low ratio pay amount to do amount, and recent large spending activities. At 504, system 10 processes the events 502 to determine whether the updated events 502 match patterns linked to users. At 506, an offer is generated and transmitted to a user device relating to the updated events. The chain of events 502 have been implemented to push a creditor insurance product to people who show a trending of going to default on a credit card. The pattern feeds back to itself to seek for enhancing reoccurring behavior or a disruption to exiting behavior. Each event 502 can have both a historical aspect, similar to a memory in human brain, and a recent occurrence, similar to a context in human brain to drive the next action. The recent occurrence, i.e. context, is designed to have heavier impact in the cognitive compulsive driven actions. There is no limit on where the events can be sourced from, i.e. any integrated channels, third party data sources, historical databases, web/mobile platforms, and so on. The response to the offer or nudge can become a new event back to the pattern to indicate how reactive an individual is to these triggers. This pattern is also applicable to generate other financial insights which can support offering of other financial or insurance products.

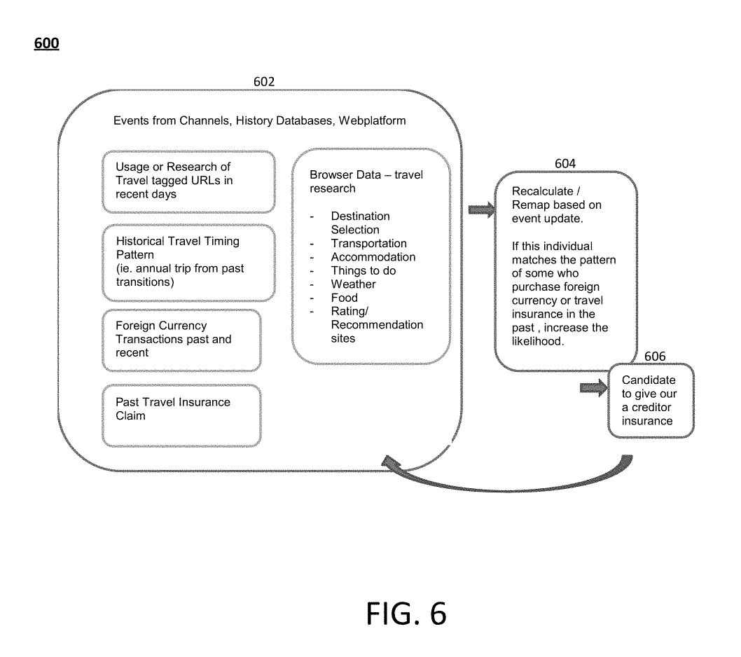

FIG. 6 is an example diagram of events 602 according to some embodiments. The events 602 can be generated from data sources such as channels, databases and web platform. In this example, events 602 include usage or research events, historical timing patterns or events, foreign-currency transaction events, past travel insurance claims, and browser data events. At 604, system 10 processes the events 60 to determine whether the updated events match patterns linked to users. At 606, an offer is generated and transmitted to a user device relating to insurance and the updated events. The chain of events 602 has been implemented to trigger positive response to travel products for a financial institution. The pattern feeds back to itself to seek for enhancing reoccurring behavior or a disruption to exiting behavior. Similarly, each event 602 can have both a historical aspect and a recent occurrence. The recent occurrence, i.e. context, is designed to have heavier impact in the cognitive compulsive driven actions. There is no limit on where the events can be sourced from, i.e. any integrated channels, 3rd party data sources, historical databases, web/mobile platforms, etc. The response to the offer or nudge can become a new event back to the pattern to indicate how reactive an individual is to these triggers. This pattern is also applicable to retail, travel, hospitality, and other relevant industry.

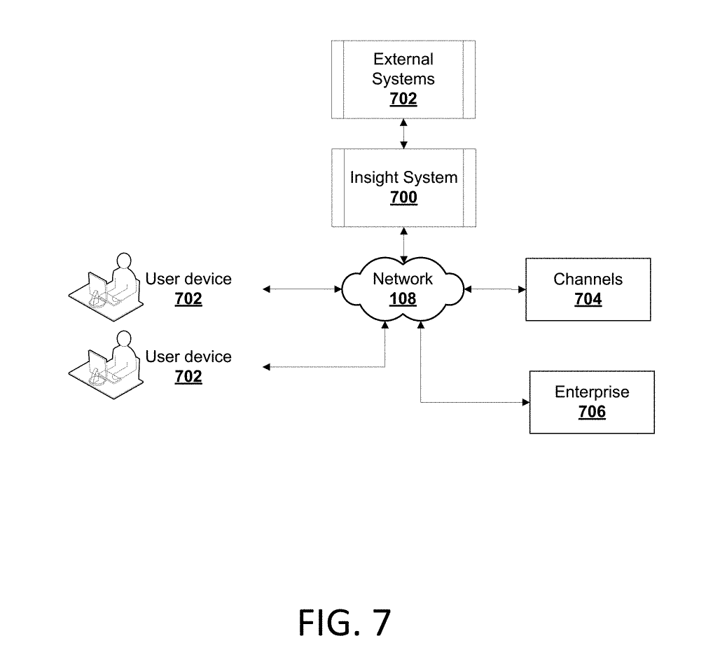

FIG. 7 is a schematic diagram of a system 700 for generating and processing chain-of-events for decision making according to some embodiments. System 700 can include component shown in system 400 of FIG. 4 for example. System 700 connects to external systems 702 including data sources and partner hubs. System 700 also connects to channels 704 via network 108 to exchange data. System connects to enterprise 706 to exchange data. System 700 connects to user device 702 generate and display in interface on the display of user device 702 the interface can include different visual representations of events, insights, and chain of events automatically extracted and generated by system 700.

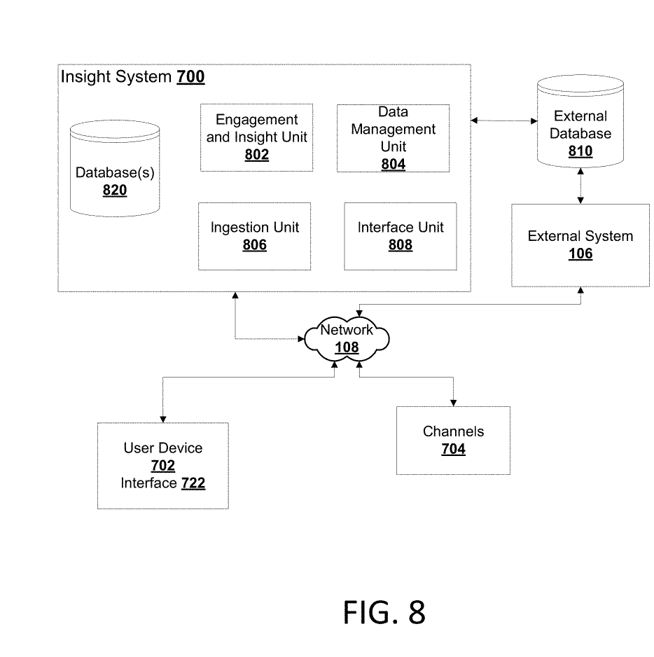

FIG. 8 is a schematic diagram of a system 700 for generating and processing chain-of-events for decision making according to some embodiments. System 700 can include an insight and engagement unit 802, a data management unit 804, and ingestion unit 806, an interface unit 808. User device 702 can have an interface 722 to display visual elements representing events, insights, and chain of events. The insight and engagement unit 802 can process real-time data feeds to generate events, insights and chain of events, such as is described herein in relation to FIG. 4. The insight and engagement unit 802 implements machine learning in order to automatically extract patterns from data sources to generate the events in insights. Insight and engagement unit 802 defines a sequence for events in order to generate a chain of events. Data management unit 804 can include data caching and data blending tools in order to aggregate data in real time and store different data views. Ingestion unit 806 processes data in real time in order to provide an updated and aggregated view of data to different components. Interface unit 808 generates visual elements that correspond to events, insights, and chain of events that are automatically generated from data sources. Interface unit 808 interacts with interface 722 nor to update the visual elements displayed as part of the display of user device 702. System 700 stores the events in insights in databases 820.

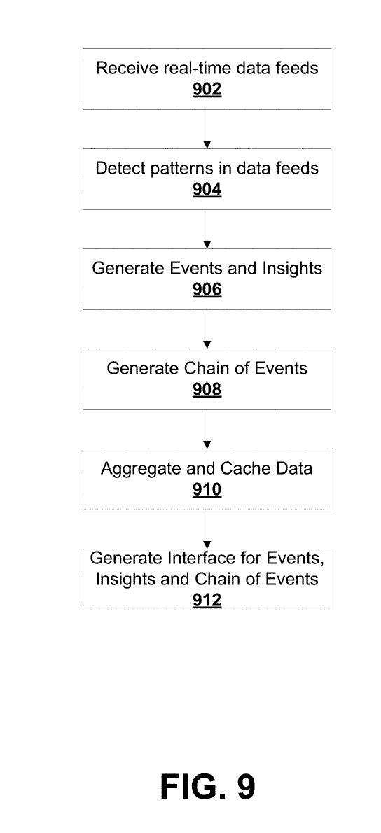

FIG. 9 is a schematic diagram of a process for generating and processing chain-of-events for decision making according to some embodiments. At 902, system 400 receives real-time data feeds. The process involves generating or obtaining a set of event rules that define events as a function of a pattern of data relating to customer transaction. The process involves receiving or retrieving, by a processor, real-time transaction data feeds having a plurality of data sets. The process involves aggregating the real-time transaction data feeds with daily data feeds to generate an aggregated transaction data feed. At 904, system 400 detects patterns in the data feeds using event rules. Example events are described herein. The process involves generating an intermediate data stream by extracting, using the processor, data structures for event outputs by evaluating the aggregated transaction data feed against the set of event rules. At 906, system 400 generates events in insights using the extracted patterns from the data feeds. At 908, system 400 generates a chain of events by creating a sequence of events in insights. The process involves generating a set of insight rules as a function of a pattern relating to customer decision making behaviour. The process involves generating a chain of events for a consumer by evaluating the data structures for event outputs against the insight rules. At 910, system 400 aggregates and caches data to generate a real-time and aggregated view of the data for enterprise services, models, and partners. The process involves generating, by the processor, a consumer profile based on the real-time transaction data feeds and the chain of events. The process involves applying the chain of events to produce additional consumer data and an electronic offer. The process involves updating the consumer profile by adding the additional consumer data. The process involves making available, by the processor, the consumer profile and the electronic offer through data storage or transmission. At 912, system 400 generates an interface of visual elements representing data from the customer profile, events, insights and chain of events that are automatically extracted from the data feeds. These steps may be implemented in parallel and in real time so that events in insights and aggregated data are continuously generated by system 400. The computer-implemented process enables system 400 to automatically extract, compare and distill a chain-of-events for decision making from real-time transaction data feeds.

In some embodiments, the process involves receiving confirmation of the chain of events as a machine learning feedback loop; and updating the set of event rules and the set of insight rules based on the confirmation.

In some embodiments, the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

In some embodiments, the data channels comprise web channels, mobile channels, banking machine channels, call center channels, retail channels, bank channels, and email channels.

In some embodiments, the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

In some embodiments, a set of curation rules ensure data from all sources are reliable and retrievable in an enterprise view.

In some embodiments, the set of event rules include a weight for relevancy, the weight evaluated based on feedback to drive changes of the weighting of each event rule dynamically based on machine learning component such that new and updated event rules feedback in real time for real-time data processing.

The disclosure herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Some embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The term “connected” or “coupled to” may include both direct coupling (in which two elements that are coupled to each other contact each other) and indirect coupling (in which at least one additional element is located between the two elements). “Coupled to” or “coupled with” may include both wired connection and wireless connection.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including in some embodiments computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed here is:

1. A computer-implemented process for automatically extracting, comparing and distilling a chain-of-events for decision making from real-time transaction data feeds, comprising:
generating or obtaining a set of event rules that define events as a function of a pattern of data relating to customer transaction;
receiving or retrieving, by a processor, real-time transaction data feeds having a plurality of data sets;
aggregating the real-time transaction data feeds with daily data feeds to generate an aggregated transaction data feed;
generating an intermediate data stream by extracting, using the processor, data structures for event outputs by evaluating the aggregated transaction data feed against the set of event rules;
generating a set of insight rules as a function of a pattern relating to customer decision making behaviour;
generating a chain of events for a consumer by evaluating the data structures for event outputs against the insight rules;
generating, by the processor, a consumer profile based on the real-time transaction data feeds and the chain of events;
applying the chain of events to produce additional consumer data and an electronic offer;
updating the consumer profile by adding the additional consumer data; and
making available, by the processor, the consumer profile and the electronic offer through data storage or transmission.

2. The process of claim 1 further comprising:
receiving confirmation of the chain of events as a machine learning feedback loop; and
updating the set of event rules and the set of insight rules based on the confirmation.

3. The process of claim 1 wherein the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

4. The process of claim 1 wherein the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

5. The process of claim 1 wherein the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

6. The process of claim 1 wherein the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

7. The process of claim 6 wherein the data channels comprise web channels, mobile channels, banking machine channels, call center channels, retail channels, bank channels, and email channels.

8. The process of claim 1 wherein the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

9. The process of claim 1 further comprising a set of curation rules that ensure data from all sources are reliable and retrievable in an enterprise view.

10. The process of claim 1 wherein the set of event rules include a weight for relevancy, the weight evaluated based on feedback to drive changes of the weighting of each event rule dynamically based on machine learning component such that new and updated event rules feedback in real time for real-time data processing.

11. A computer system for extracting, comparing and distilling a chain-of-events for decision making comprising:
rules engine for generating or obtaining a set of event rules that define events as a function of a pattern of data relating to customer transaction;
a customer hub for ingesting, aggregating and caching, real-time transaction data feeds having a plurality of data sets, the customer hub aggregating the real-time transaction data feeds with daily data feeds to generate an aggregated transaction data feed;
a model manager for generating models for a set of insight rules as a function of a pattern relating to customer decision making behaviour;
an insight hub for generating an intermediate data stream by extracting, using the processor, data structures for event outputs by evaluating the aggregated transaction data feed against the set of event rules;
an engagement hub generating a chain of events for a consumer by evaluating the data structures for event outputs against the insight rules;
the engagement hub for applying the chain of events to produce additional consumer data and an electronic offer; and
the customer hub for generating, by the processor, a consumer profile based on the real-time transaction data feeds and the chain of events, updating the consumer profile by adding the additional consumer data, and making available, by the processor, the consumer profile and the electronic offer through data storage or transmission.

12. The system of claim 1 the customer hub for:
receiving confirmation of the chain of events as a machine learning feedback loop; and
updating the set of event rules and the set of insight rules based on the confirmation.

13. The system of claim 1 wherein the real time transaction data feeds comprise credit card or debit card transactions, and include a customer identifier and a plurality of time codes, the daily data feeds having a corresponding customer identifier, wherein the set of event rules correlate the data feeds using the customer identifier and the plurality of time codes.

14. The system of claim 1 wherein the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

15. The system of claim 1 wherein the real time transaction data feeds comprise data defining customer interactions with a web application and a mobile application, the real time transaction data feeds include a customer identifier and a plurality of time codes, the daily data feeds having a corresponding customer identifier, wherein the set of event rules correlate the data feeds using the customer identifier and the plurality of time codes.

16. The system of claim 1 wherein the real time transaction data feeds comprise data defining customer interactions with data channels, the real time transaction data feeds include a customer identifier and a plurality of time codes, the daily data feeds having a corresponding customer identifier, wherein the set of event rules correlate the data feeds using the customer identifier and the plurality of time codes.

17. The system of claim 16 wherein the data channels comprise web channels, mobile channels, banking machine channels, call center channels, retail channels, bank channels, and email channels.

18. The system of claim 1 wherein the real time transaction data feeds include a customer identifier and a plurality of time codes, the daily data feeds having a corresponding customer identifier, wherein the set of event rules correlate the data feeds using the customer identifier and the plurality of time codes, the daily data feeds comprising account data, customer data, historical transaction data, campaign data, offer data, and historical scores.

19. The system of claim 1 wherein the set of event rules include a weight for relevancy, the weight evaluated based on feedback to drive changes of the weighting of each event rule dynamically based on machine learning component such that new and updated event rules feedback in real time for real-time data processing.

20. A computer device for extracting, comparing and distilling a chain-of-events for decision making, the device comprising a processor and a memory, the processor being configured to:
generate or obtain a set of event rules that define events as a function of a pattern of data relating to customer transaction;
receive or retrieve, by a processor, real-time transaction data feeds having a plurality of data sets;
aggregate the real-time transaction data feeds with daily data feeds to generate an aggregated transaction data feed;
generate an intermediate data stream by extracting, using the processor, data structures for event outputs by evaluating the aggregated transaction data feed against the set of event rules;
generate a set of insight rules as a function of a pattern relating to customer decision making behaviour;
generate a chain of events for a consumer by evaluating the data structures for event outputs against the insight rules;
generate, by the processor, a consumer profile based on the real-time transaction data feeds and the chain of events;
apply the chain of events to produce additional consumer data and an electronic offer;
update the consumer profile by adding the additional consumer data;
make available, by the processor, the consumer profile and the electronic offer through data storage or transmission;
receive confirmation of the chain of events as a machine learning feedback loop; and
update the set of event rules and the set of insight rules based on the confirmation.
